(19) United States
(12) Patent Application Publication
(10) Pub. No.: US 2008/0308471 A1
(43) Pub. Date: Dec. 18, 2008

(54) Method for Detecting and Removing Foreign Bodies

(76) Inventors: Reinhold Huber, Furstenfeld (AT); Christian Pansinger, Graz (AT)

Correspondence Address: COLLARD & ROE, P.C., 1077 NORTHERN BOULEVARD, ROSLYN, NY, 11576, US

(21) Appl. No.: 11/659,182

(22) PCT Filed: Aug. 3, 2005
(86) PCT No.: PCT/EP2005/053804

§ 371 Date: Feb. 2, 2007

(30) Foreign Application Priority Data
Aug. 5, 2004 (AT) GM 562/2004

(51) Int. Cl. B07C 5/342

(52) U.S. Cl. 209/577

(57) ABSTRACT

To create a method that can be carried out using known broken glass sorting and detecting devices so the advantages of these devices with respect to robustness and interchangeability are retained but enhanced blow-out accuracy compared with the known method is made possible, it is provided that each of the light sources (7) emitting light beams (14) is associated with position data and with the instant of the activity of a light source (7), of which the position data is linked with the detected intensity values when the light beams (14) impinge on the photocell (18) associated with each light source (7) and this linked data is stored, together with the time data at the instant of detection, in a memory, preferably the control unit (10), and this linking data is linked to linking data obtained in the same way at a later instant, to produce a two-dimensional image of the broken glass material flow which is used as a basis for activation of the blow-out nozzles (11) by the control unit (10).

### FIELD OF THE INVENTION

The present invention relates to a method for detecting and removing foreign bodies in a broken glass material flow conveyed through a detector, in which pulsed light beams impinge through the broken glass material flow onto photocells at an intensity which is dependent on the transmission properties of the objects forming the broken glass material flow and in the event of a predefined intensity threshold not being attained a control unit connected to the photocell activates blow-out nozzles arranged downstream of the photocell, the nozzles deflecting foreign bodies in the broken glass material flow from the broken glass material flow to a predefined location.

### PRIOR ART

This method is already being used in a specific type of broken glass sorting device. In this case the detector is inserted as a one-piece unit into the broken glass sorting device and may consequently be easily replaced again. It substantially comprises light sources, photocells and the lens systems focussing the light beams emitted by the light sources onto the photocells, there being a free space between the light sources, which are preferably constructed as infrared diode light sources, and the photocells, through which space a material slide for the broken glass flow is guided. A plurality of light sources, for example eight, is combined into a transmitter unit and opposes a receiver unit which substantially comprises a lens system and a photocell. The lens system is used to focus the light beams of the eight light sources onto the photocell. A plurality of transmitter units is preferably arranged distributed over the entire width of the material slide. The light sources of each transmitter unit are not simultaneously active but are successively activated at short intervals, of for example 1 ms, so in each case the first, then the second, then the third, etc. light sources of each transmitter unit are simultaneously active and the emitted light beams impinge through the broken glass material flow flowing past, via the respectively associated lens system, onto the likewise associated photocell. Each transmitter/receiver unit thus forms a detecting path with which a blow-out nozzle is associated in a further progression, the nozzle being activated by a control unit. The control unit simultaneously controls activation of the light sources and receives the signals from the photocells or measures the voltage produced at this location by impingement of the light beams.

In the event of one-off non-attainment of a predetermined threshold of the measured light intensity of a detecting path (a LED pulse→resolution or picture element) by the corresponding photocell thereof, an analogue comparator, which is a component of a control unit, generates a valve control signal. The control unit activates the blow-out nozzles associated with the detecting path and arranged downstream of the transmitter/receiver unit by taking account of a certain delay, which results from the movement of the detected possible foreign body in the direction of the material flow.

This known broken glass sorting device, together with the detector, has the advantage that it is very inexpensive in terms of acquisition and is also distinguished by great compactness and robustness. The possibility of replacing the detector as a whole means that drawn-out adjustment by the customer and operator becomes superfluous; this can be done by the manufacturer. The detector then merely has to be inserted into the broken glass sorting device by the customer and operator.

The method used in this connection for detecting and removing the foreign bodies has proven to be disadvantageous however, in particular because it is a path-oriented method (more precisely still: picture element-oriented), i.e. decisions as to whether the respective blow-out nozzle of a detecting path should be activated or not are based merely on the single item of information as to whether a photocell of a detecting path (=receiver unit) falls below the threshold or not. No statements can be made about the shape, size, position or homogeneity of the possible foreign body in the known method. Accordingly misidentifications and inaccuracies during blowing out cannot be completely ruled out.

### DESCRIPTION OF THE INVENTION

It is therefore the object of the present invention to prevent this drawback and to provide a method of the type described in the introduction which can be carried out with the known broken glass sorting devices and detectors described in the introduction, so the described advantages of these devices with respect to robustness and interchangeability are retained but enhanced blow-out accuracy compared with the known method is made possible.

According to the invention this is achieved by the characterising features of claim 1.

By linking the position data with the intensity values detected when the light beams impinge on the photocell associated with each light source, and storing this linked data together with the time data at the instant of detection in a memory, the position of a point of the object in the broken glass material flow may be exactly established. By linking this data with data determined in the same way at a later instant, a digital image of the broken glass material flow can be produced and geometric data, such as shape, size and position of the individual objects, determined therefrom.

At a certain instant t=0 the light beams emitted by the activated light sources impinge on an associated photocell with a certain intensity I. If it is assumed that the light sources are arranged distributed over the entire width x of the broken glass material flow conveyed via a material slide, and therefore the emitted light beams also cover this width, a one-dimensional image of the broken glass material flow, in other words an image of one line over the entire width of the broken glass material flow, is thus produced at the instant t=0. At instant t=1 the light beams emitted by the activated light sources and impinging on the photocells in turn provide a one-dimensional image of the broken glass material flow. Together with the data previously stored at instant t=0 a two-dimensional image of the broken glass material flow is thus already produced however since at instant t=1 the flow has already moved on by a distance y (flow direction of the broken glass material flow) and it is thus possible therefore to also detect extension of the objects forming the broken glass material flow in the y direction. Therefore of the respective objects detected point-by-point it is not only the x coordinates of the detected points of the objects, and thus also possible foreign bodies, that are known on the basis of the position data of the light sources but, on the basis of the time data, the extension in the flow direction of the broken glass material flow (y direction) as well. In other words the respective data detected line-by-line in each case (position data, intensity values) is combined to give various instants, thus producing a digital, two-dimensional image of the broken glass material flow.

The characterising features of claim 2 prove to be advantageous since by classifying the intensity into different value ranges data reduction is achieved without any significant loss of information. The intensity ranges established in this case have been determined from experimental values and simultaneously form the basis of simple image processing since the detected objects can be classified with respect to their blow-out relevance.

A further and important advantage results from grouping the light sources, according to characterising features of claim 3, into transmitter group units and successive activation of the light sources of a transmitter group unit at intervals, or, according to claim 4, at least one light source per transmitter group unit at the same time. This avoids scattered light on the one hand, thereby increasing the accuracy of the detector, and on the other hand the measured intensity values of light beams emitted by light sources located side by side may however be linked with each other very effectively, although there is only one photocell available for a plurality of light sources. The characterising features of claim 5 can also increase the blow-out accuracy. The characterising features of claims 6 and 7 are used to process the identified data and display it to the user. Above all the additional inclusion of adjacent picture elements of the two-dimensional image, whereby characteristic features are recognised, and thus critical glass objects are not associated with CSP (ceramic, stone, porcelain) objects, and consequently are not discarded as foreign objects either, resulting in a significant increase in blow-out accuracy and energy being conserved moreover owing to the reduction in the blow-out operations, proves to be advantageous in this connection.

### BRIEF DESCRIPTION OF THE FIGURES

A detailed description of the invention with reference to an embodiment will be made hereinafter. In the drawings:

FIG. 1 shows a simplified schematic view of a known sorting device for carrying out the method according to the invention,

FIG. 2 shows a simplified schematic view of the detector,

FIG. 3 shows a detailed view of the arrangement of the light sources of a transmitter device,

FIG. 4 shows a schematic view of a detector,

FIG. 5 shows a graph with defined thresholds and value ranges,

FIG. 6 shows a simplified schematic view of a transmitter unit group and the algorithm for activating the blow-out nozzles.

### METHODS FOR IMPLEMENTING THE INVENTION

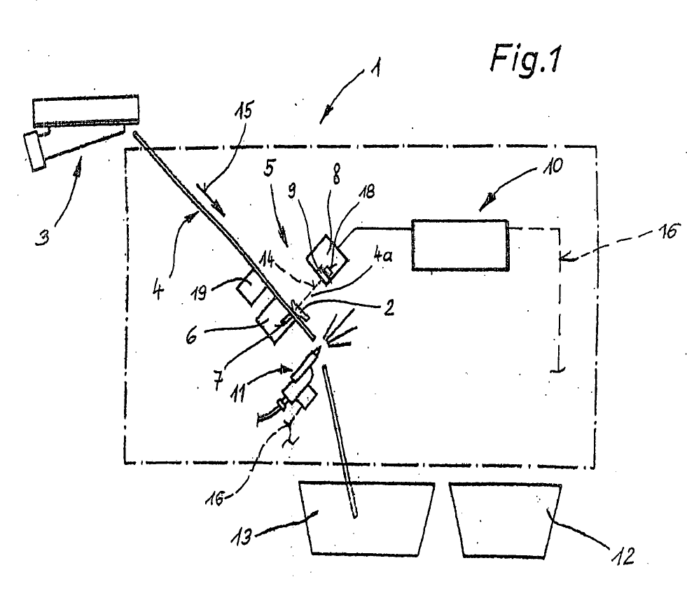

FIG. 1 schematically shows a sorting device 1 for sorting out foreign bodies 2, such as metal parts, ceramic or earthenware pieces, from a broken glass material flow. There is provided in this device 1 a material slide 4, which adjoins the delivery station 3, and in the lower region of which a detector 5 for detecting foreign bodies 2 in the broken glass flow is arranged. This detector 5 substantially comprises at least one transmitter unit 6 with successively pulsed light sources 7, preferably infrared diode light sources, and at least one receiver unit 8 which comprises a lens system 9 and a photocell 18 arranged behind it, and a control unit 10 which is connected to blow-out nozzles 11 arranged at the end of the material slide 4 and controls these nozzles as a function of the signals of the transmitter and receiver units, as will be described in more detail hereinafter. The blow-out nozzles 11, which are arranged at the end of the material slide 4 downstream of the transmitter and receiver units 6, 8, are simultaneously located in a region in which the broken glass material flow follows the characteristic of a bomb trajectory. When the blow-out nozzles 11 are activated by the control unit 10 the foreign bodies 2 are deflected from the broken glass material flow, so they fall into a waste container 12 and are thus separated from the broken glass falling into a different container 13.

The detector 5 itself, as what is known as a “black box”, can be assembled on the sorting device 1, and removed therefrom again, in a few manoeuvres, so it can be replaced within a few minutes.

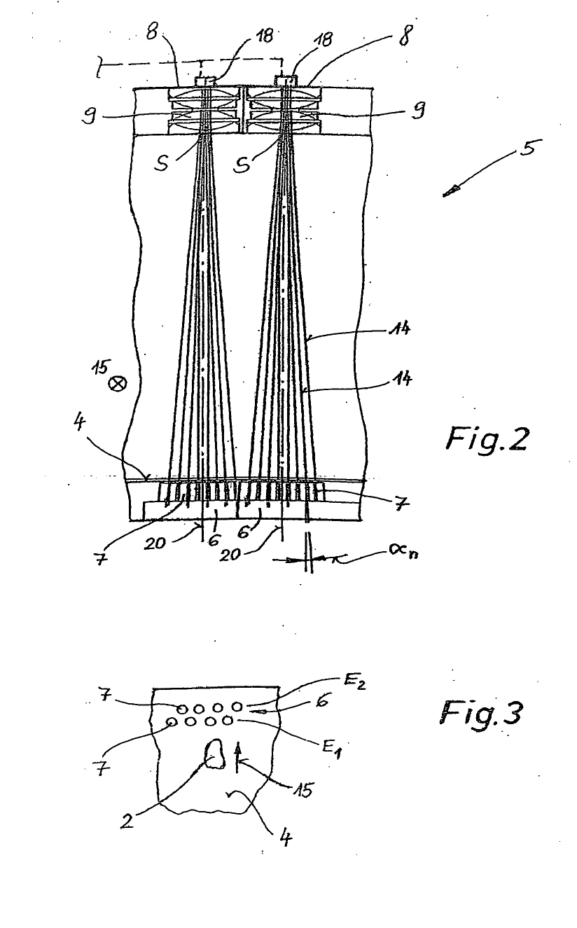

As already mentioned, the transmitter unit 6 comprises light sources 7, preferably infrared diode light sources emitting straight light beams 14. FIG. 1 shows a simplified view of a light beam 14 of this type between the transmitter unit 6 and the receiver unit 8. The light beam 14 is deflected or focussed by a lens system 9, which is part of the receiver unit 8, onto a photocell 18 (see FIG. 2). The signal produced in the process is forwarded to the control unit 10.

The light sources 7 are arranged below the material slide 4, which is visually transparent, and in particular below the detecting section 4a, so the broken glass material flow flows past the light sources 7 almost directly. Alignment preferably takes place in this case such that the light sources 7 are aligned with the region of the interesting point S of the optical axis 20 of the lens system 9 with lens system 9, independently of their arrangement and placement in relation to the receiver unit or the material slide 4.

FIG. 2 and FIG. 3 shows preferred possible arrangements of the light sources 7 with converging light beams. Of course the invention can, however, also be used in systems with light beams that extend parallel to each other. These systems are still being used but have the drawback that the light beams that are more remote from the optical axis 20 are focussed onto the photocell 18 with a certain fuzziness, and this adversely affects the blow-out accuracy.

In FIG. 2 the light sources 7 or a transmitter unit 6 are arranged in a plane E₁, the optical axis 20 of the lens system 9 of the respective associated receiver unit 8 likewise being located in this plane E₁. The material flow direction points in FIG. 2 perpendicularly onto the page and is designated by reference numeral 15. FIG. 2 shows a variant with two transmitter units 6, each with a number of light sources 7 and two respectively associated receiver units 8, each with a lens system 9 and a photocell 18. Of course the width of the material slide 4 can also be covered by a transmitter unit 6 and a receiver unit 8 or by more than two transmitter and receiver units 6, 8.

The light sources 7 not situated in the optical axis 20 are aligned so as to be inclined by an angle (α_{1,2,3, . . . n}) to the optical axis 20, so the emitted light beams 14 impinge in the intersecting point S of the optical axis 20 with the lens system 9 of a receiving unit 8. This alignment ensures that the light beams 14 that are obliquely incident are deflected parallel to the optical axis 20 and optimum imaging on the photocell 18 is thus achieved. It should be noted that with this preferred embodiment of the invention the light beams 14 of the individual light sources 7 never impinge on the intersecting point S at the same time, for which reason interference cannot occur either. The light sources 7 are activated in a pulsed manner, so one individual light source of a transmitter unit 6 is active in each case.

FIG. 3 shows a schematic plan view of a possible further preferred embodiment of light sources 7 behind the visually transparent material slide 4. As may easily be seen, the light sources 7 are aligned one behind the other and are laterally offset in two planes E₁, E₂ in the material flow direction, resulting in even more accurate resolution of the detector 5. This offset in the material flow direction 15 of the detected intensity values is corrected by means of a filter and aligned before the data is supplied to image processing.

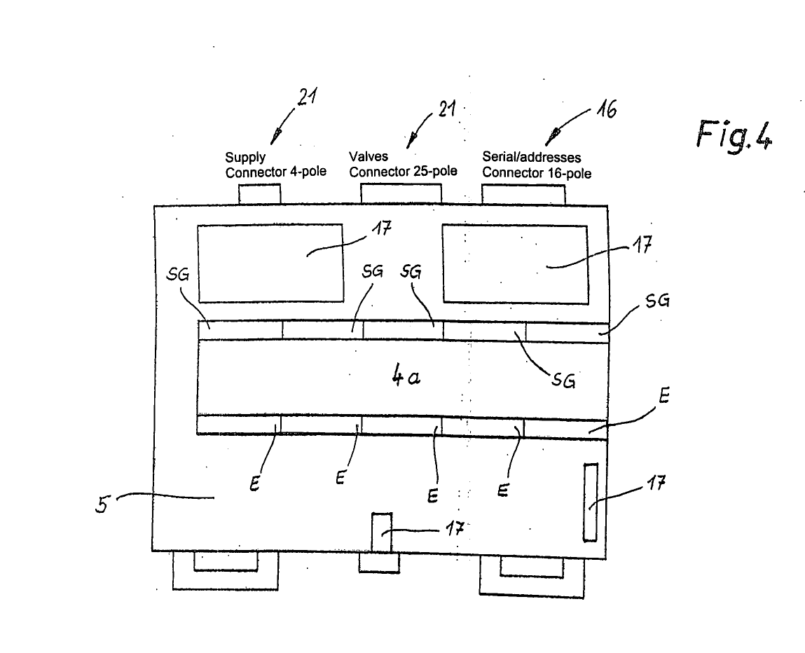

In a preferred embodiment a detector 5 (See FIG. 4) consists of five transmitter unit groups SG operating in parallel, each with thirty-two diode light sources 7. The diode light sources 7 of a sender unit group SG are in turn combined to give four transmitter units 6 of eight diode light sources 7 each. A receiver unit group E, which consists of four receiver units 8, is associated with each transmitter unit group SG. The light beams emitted by each transmitter unit 6 are aligned with the lens system 9 and consequently with the photocell 18 of that of the receiver unit 8 associated with the respective transmitter unit 6. Each receiver unit group E therefore comprises four receiver units 8 and therefore four lens systems 9 and four photocells 18. All receiver units 8 combined comprise twenty lens systems 9 and twenty photocells 18. The detector 5 that can be seen in FIG. 4 also exhibits connections 21 for power supply and connection to the blow-out valves 11 as well as data line connections 16 and various operating elements 17.

All thirty-two diode light sources 7 of each of the transmitter unit groups SG operating in parallel are successively activated in groups within the cycle time of 1 ms, in other words for example the respective first diode light sources of each transmitter unit group SG are simultaneously activated. Once they have been switched off the respective second diode lights sources 7 of each transmitter unit group SG are activated, etc. 160 signals are therefore acquired in one cycle (corresponds to 32 lines) from the total of twenty photocells 18. This corresponds to one-off detection of the entire sorting width of the material slide 4 of 500 mm. It should be noted at this point that the described variant is to be understood merely as an example and that the number of transmitter unit groups SG, transmitter units 6 as well as diode light sources 7 and receiver unit groups E, receiver units 8, and therefore lens systems 9 and photocells 18, has been randomly selected and has proven to be reliable in practical tests. Of course it is completely clear to a person skilled in the art that other divisions may also lead to a good result without departing from the actual scope of the invention.

In previous systems a type of “flash photograph” has been produced by the pulsed light sources 7 and this, as a single item of information, based on one point in an isolated manner, causes a YES or NO decision per light source 7 and consequently the associated blow-out nozzle 11 is, if required, activated with a delay by the control unit 10. This has an adverse effect in this regard since a foreign body 2 is already assumed in the event of one-off non-attainment of the threshold and therefore the associated blow-out nozzle 11 is consequently activated. No difference is found in this case, however, between objects made of glass, which are provided for example with paper or particles of dirt, and objects, made for example of ceramic, stone or porcelain, which constitute an actual foreign body 2, and therefore non-foreign bodies are also discarded and the level of elimination is unnecessarily reduced as a result.

This data generated by a large number of pulsed light sources 7 and therefore supplied by the system and consequently stored, produces a digital image with a high information content and high resolution, comparable for example with pixels or picture elements, thus in the preferred embodiment 32 lines with 5 points in each case, in other words 160 individual picture elements with one-off scanning of the entire width of the material slide 4.

The intensity value registered by the respective photocell 18 is subsequently linked by the control unit 10 with the position data of the light source 7 emitting the light beam 14, of which the intensity has been registered, and is stored together with time data which corresponds to the instant of registration of the intensity value. This process takes place for each received intensity value which is registered on the basis of activation of the individual light sources 7 and impinging of the emitted light beams 14 onto the associated photocells 18. A defined point may therefore be placed on an imaginary straight line at an instant t=0 for each intensity value registered by a photocell 18. At instant t=32 μs this process is repeated, so in the described embodiment each of the 32 diode light sources 7 of a transmitter unit group SG has been activated after approx. 1 ms and therefore the entire width of the material slide 4 has been scanned. As a result of each detected intensity of a light beam 14 the control unit 10 produces in its digital memory a defined point on an imaginary straight line or an imaginary line. A digital image of the broken glass material flow is thus produced over the entire width of the material slide 4 within approx. 1 ms, and this corresponds in practice to a single instant. Within approximately the next 1 ms the broken glass material flow has already advanced in the flow direction, the entire procedure is repeated and the next line is scanned and a corresponding digital image created, etc., so in this way, by linking the position data and intensity values and the time data, the entire broken glass material flow may be digitally detected. Thus it is possible not only to detect whether there is a possible foreign body 2 in the broken glass material flow, but also the position, size and shape thereof. This circumstance subsequently contributes to the fact that the blow-out nozzles 11 may be activated more accurately, and in particular their period of activation may be matched to the shape and size of a foreign body 2.

Perfect simulation of the broken glass material flow is thus possible by synchronisation of the line-by-line reading-in of data and by straightforward image processing the requisite information for controlling the nozzles for blowing out the foreign bodies may be calculated therefrom.

Use of the transmission behaviour which has a known relationship with the material (glass, ceramic, etc.) leads to further improvement of the selectivity. An image of the transmission properties is created on the basis of the measured intensity and these properties are divided into or allocated to, for example, four value ranges, namely:
H (background): no object between transmitter and receiver units (for example value range for intensity ≧95%)
G (glass): glass object between transmitter and receiver units (for example value range for intensity between ≧30 and <95%)
P (paper): shard of glass with paper between transmitter and receiver units (for example value range intensity between ≧17 and <30%)
K (CSP): ceramic, stone or porcelain object between transmitter and receiver units (for example value range intensity >17%)

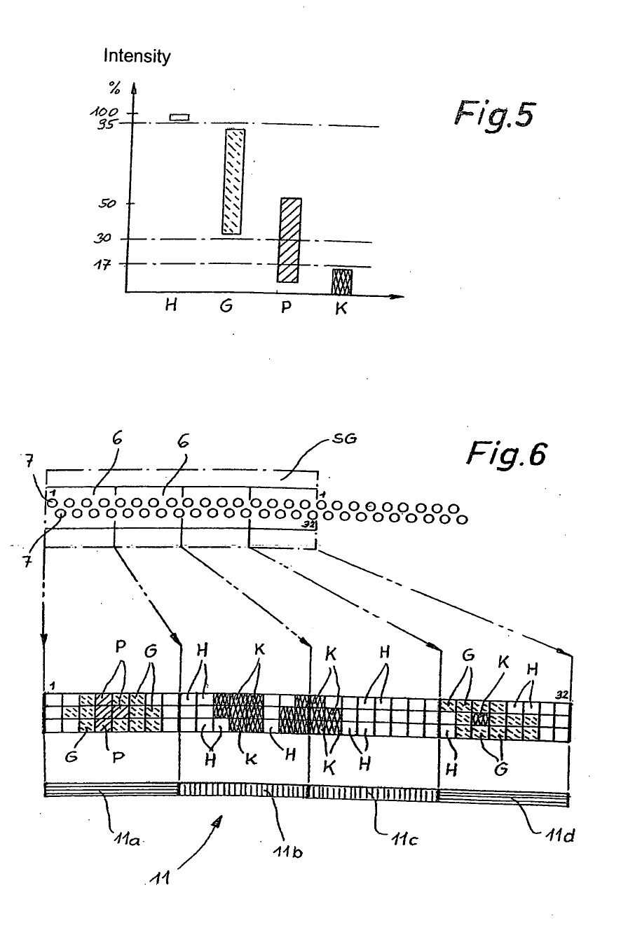

As shown in FIG. 5 the determined individual signals are classified by allocation to the corresponding value ranges between the defined thresholds and are stored. This results in a reduction in the data although this does not represent a significant loss of information for further determination with respect to activation of the blow-out valves 11.

As may also be seen from the illustration, there are partial overlaps in the value ranges. This may be attributed to the fact that for example thick or dark glass objects provide similar intensity values to, for instance, glass with paper, or CSP objects in turn provide similar intensity values to, for instance, glass that is affected by dirt. To reduce the glass loss during sorting out, and to increase the efficiency of broken glass sorting devices as a consequence, the individual signals are linked with adjacent signals and a suitable algorithm for activating the blow-out nozzles 11 is developed therefrom.

FIG. 6, with reference to an example, shows a simplified algorithm for activating the blow-out nozzles 11 for a transmitter unit group SG comprising four transmitter units 6 and eight light sources 7 receptively. It may be seen therefrom how the signals produced by 32 light sources 7 and already classified are stored in lines (only three lines shown by way of simplification). By linking the individual signals proximity relationships are also taken into account and as a result the blow-out nozzles 11 may be activated in a more targeted manner.

Basically the homogeneity of an object is decisive. If a homogenous body cannot be identified, i.e. no low values for the intensity can be identified, there is no activation of the blow-out nozzles 11 either.

In the present example the blow-out nozzles 11b and 11c are activated for blowing out on the basis of the identified foreign body 2 by the signals K repeatedly classified as CSP objects and stored. By contrast, the blow-out nozzle lid is not activated for blowing out, despite an identified foreign body 2 by a single signal K classified as a CSP object, but by also taking account of the adjacent signals G classified as a glass object. This can, for example, be attributed to the fact that there are isolated particles of dirt on the glass object.

The blow-out nozzle 11a is not activated either on the basis of the numerous stored signals G and P since, despite some soiling by paper, a glass object is clearly identified.

Various critical glass objects, such as shards of wire glass or fragments of the bottom of a bottle, may also be identified, and consequently not be discarded, as non-foreign bodies by this linking of the individual signals. This can be attributed to the fact that the reinforced bottom edge (crescent shape) provides signals K classified as a CSP object, but in conjunction with the signals G classified as a glass object due to the adjacent, thinner base part, is identified as a whole as a glass object. Consequently distinction from for instance a ceramic handle, which provides predominantly classified signals K and does not exhibit any adjacent signals G, is possible. Foreign bodies are identified more reliably as a result of the procedure and non-foreign bodes (shards of glass) are therefore discarded significantly less, so, consequently, the efficiency is also significantly increased. The reduction in the blow-out procedures also saves energy in the form of expensive compressed air moreover.

The described method utilising the transmission properties of objects is therefore not restricted merely to broken glass sorting devices but may also be used when sorting other materials, such as minerals and quartzes.

To further increase the efficiency in detection and separation of foreign bodies 2, and as a consequence to keep the recovery of correctly sized granulate as low as possible, an additional non-ferrous detector 19 is, as may be seen in FIG. 1, provided in the region of the material slide 4 upstream of the described transmitter and receiver units 6, 8. This non-ferrous detector 19 is also connected to the control unit 10. Its provided data is also linked with the data already described and contributes to renewed improvement in the digital creation of an image of the broken glass material flow, and thus to even more accurate blowing out.

1: Method for detecting and removing foreign bodies (2) in or from a broken glass material flow conveyed through a detector, in which light beams (14) from a plurality of successively activated light sources (7) impinge through the broken glass material flow onto a photocell (18) at an intensity which is dependent on the composition of the broken glass material flow, and in the event of a predefined intensity threshold not being attained a control unit (10) connected to the photocell (18) activates blow-out nozzles (11) arranged downstream of the photocell (18), the nozzles deflecting foreign bodies (2) in the broken glass material flow from the broken glass material flow to a predefined location, wherein each of the light sources (7) emitting light beams (14) is associated with position data, and with the instant of the activity of a light source (7) its position data is linked with the detected intensity values when the light beams (14) impinge on the photocell (18) associated with each light source (7) and this linked data is stored, together with the time data at the instant of detection, in a memory, preferably of the control unit (10), and this linking data is linked to linking data obtained in the same way at a later instant, to produce a two-dimensional image of the broken glass material flow which is used as a basis for activation of the blow-out nozzles (11) by the control unit (10).

2: Method according to claim 1, wherein, as a function of the transmission properties of the objects forming the broken glass material flow, different intensity value ranges are provided in which the intensities detected at the photocells (18) are classified.

3: Method according to claim 1, wherein the light sources (7) are combined into transmitter units (6), and a photocell (18) and a lens system (9) are associated with each transmitter unit (6), a plurality of transmitter units (6) being combined into a transmitter group unit (SG) and the light sources (7) of a transmitter group unit (SG) being successively activated.

4: Method according to claim 3, wherein in each case at least one light source (7) per transmitter group unit (SG) is activated at the same time.

5: Method according to claim 1, wherein the linking data is combined with additional data from a non-ferrous detector (19).

6: Method according to claim 1, wherein the linking data is supplied to electronic image processing.

7: Method according to claim 6, wherein the data processed by means of image processing is displayed on a monitor.
